(19) United States
(12) Patent Application Publication
(10) Pub. No.: US 2012/0113164 A1
(43) Pub. Date: May 10, 2012

(54) Liquid Crystal Display Device And Method For Controlling Display Of Liquid Crystal Display Device

(75) Inventors: Hiroyuki Furukawa, Osaka (JP); Kazuyoshi Yoshiyama, Osaka (JP); Yasuhiro Ohki, Osaka (JP); Masafumi Ueno, Osaka (JP); Takashi Ishizumi, Osaka (JP); Kenji Takase, Osaka (JP)

(73) Assignee: SHARP KABUSHIKI KAISHA, Osaka-shi, Osaka (JP)

(21) Appl. No.: 13/382,358

(22) PCT Filed: Mar. 31, 2010
(86) PCT No.: PCT/JP2010/002367

§ 371 Date: Jan. 5, 2012

(30) Foreign Application Priority Data
Jul. 6, 2009 (JP) 2009-160144

(51) Int. Cl. G09G 3/36; G09G 5/10

(52) U.S. Cl. 345/690; 345/102

(57) ABSTRACT

A liquid crystal data calculation section forms, on the basis of input image data, liquid crystal data to display an image on a liquid crystal panel. In at least one example embodiment, an LED data calculation section forms, on the basis of the input image data, LED data for adjusting an amount of light of an LED backlight. An LED control section controls an amount of an output current of an LED power source on the basis of the LED data, and includes a protection function of limiting the amount of the output current so that the amount of the output current does not exceed a predetermined upper limit. In a case where the amount of the output current of the LED power source is reduced to the upper limit by the LED control section, a liquid crystal transmittance correction section corrects the liquid crystal data and increases transmittance so as to compensate reduction in luminance of the backlight.

### TECHNICAL FIELD

The present invention relates to a technique by which display luminance of a liquid crystal display device employing a local dimming technique can be improved without causing an increase in consumption power.

### BACKGROUND ART

A local dimming type liquid crystal display device (i.e., a liquid crystal display device employing a local dimming control technique) controls, in accordance with an input image, luminance of a backlight and transmittance of a liquid crystal panel for each predetermined display area. Specifically, the liquid crystal display device employing the local dimming technique controls the backlight to have low luminance when a luminance area of the input image is low. This can remarkably reduce light leaking from a dark area, which light is caused by such a liquid crystal display device that the backlight always illuminates the whole screen at predetermined luminance, and therefore can greatly improve contrast in the screen. At the same time, consumption power of the backlight which mainly consumes electric power in the liquid crystal display device can be reduced.

Note that, in a case where an image having a high APL (average picture level) is inputted to the liquid crystal display device, luminance of the backlight needs to be increased with respect to the whole screen. In such case, consumption power of the liquid crystal display device is changed depending on a kind, the number, and efficiency of a light source(s) used in a backlight system.

A backlight system employing the local dimming technique generally includes LEDs (light emitting diode). In recent years, light emitting efficiency of the LEDs has been improved and is now more efficient than a CCFL (cold cathode fluorescent lamp). Accordingly, the LEDs have been increasingly used in a backlight system of a large-size liquid crystal television which has a screen larger than 40 inches.

However, heat radiation of the LEDs become more difficult because there is a demand for further thinning of the backlight system. Since the LEDs are deteriorated due to heat, an upper limit of an amount of an electric current flowing through the LEDs is set in such a manner that temperatures of the LEDs or the amount of the electric current flowing through the LEDs are or is monitored by a protection circuit provided on the backlight system side.

In the liquid crystal display device employing the local dimming control technique, the amount of the light emitted from the LEDs needs to be increased with respect to the whole screen when the input image has a high APL as described above. This causes an increase in heat generation of the LEDs. The protection circuit functions to limit the amount of the electric current which is calculated on the basis of the input image and is to be originally supposed to flow through the LEDs.

Similarly to the amount of the electric current supposed to flow through the LEDs, transmittance data of the liquid crystal panel is also calculated on the basis of the input image. However, the transmittance data is not compensated when the protection circuit is operated. In a case where an image having a high APL is inputted, the protection circuit limits the amount of the electric current of the LEDs depending on a characteristic of LED and specification of an electric power circuit. However, the transmittance data of the liquid crystal panel is not compensated. This may causes reduction in luminance of the image that the liquid crystal display device originally should display.

FIG. 9 are explanatory views each illustrating an operation of a local dimming type liquid crystal display device. FIG. 9(a) illustrates a case where an input image has a low APL, and FIG. 9(b) illustrates a case where an input image has a high APL.

In FIG. 9(a), luminance 102 of an LED and magnetic permeability 103 of a liquid crystal panel are obtained from an input image 101 having a low APL, and then a display image 104 is displayed. In FIG. 9(b), luminance 106 of an LED and magnetic permeability 107 of a liquid crystal panel are obtained from an input image 105 having a high APL, and then an amount of an electric current of an LED is limited by a protection circuit. Therefore, a display image 109, which is displayed on the basis of luminance 108 of the LED (which is lower than luminance 106 of the LED) and the magnetic permeability 107 of the liquid crystal panel, has a luminance lower than the input image 105.

An image signal processing technique has been conventionally used for improving luminance of an image. In general, inputted image data is subjected to gain processing. The gain processing is carried out with use of an LUT (look up table), for example, and is used together with offset addition as necessary.

FIG. 10 are explanatory views of a liquid crystal display device 110 in which inputted image data is subjected to gain processing on the basis of an LUT 112 of a signal processing circuit 111. FIG. 10(a) is a block diagram of the liquid crystal display device 110 in which the inputted image data is subjected to the gain processing on the basis of the LUT 112 of the signal processing circuit 111, FIG. 10(b) is a graph showing an input-output characteristic of the gain processing performed based on the LUT 112. FIG. 10(c) is a graph showing a characteristic of output luminance with respect to the inputted image data.

In a case of simply applying a gain processing to an input signal, the output will be saturated at a certain level on a high-luminance side. If such saturation on the high-luminance side causes any problem, an output gain is set to be gradually reduced on the high-luminance side. Meanwhile, if an output gain on a low-luminance side is lifted, this will cause reduction in contrast of the image data. For this reason, the output gains on the low-luminance side are set to be low.

As a result, the input-output characteristic of the gain processing is formed into an S-shape in which an output halftone is lifted as illustrated in FIG. 10(b). This improves output luminance of a halftone as illustrated in FIG. 10(c). Therefore, although maximum luminance of the image is not changed, luminance of the image can be substantially improved in general. As an example of such technique, Patent Literature 1 discloses a technique for appropriately changing a gain or an offset in accordance with luminance data of an input image.

Such technique for improving luminance of an image with use of the image signal processing technique is included as a video signal adjustment function which is provided in an image processing engine between a tuner and a panel driving circuit of a television receiver. This technique is used as a factory shipment setting (also referred to as a picture style setting) for manufactures and as an image quality adjustment function for general users.

### CITATION LIST

### Patent Literature

Patent Literature 1
Japanese Patent Application Publication Tokukaihei No. 1-281497 A (Publication Date: Nov. 13, 1989)

### SUMMARY OF INVENTION

### Technical Problem

Incidentally, a television including a local dimming type liquid crystal display device include, between an image processing engine and a panel driving circuit, a circuit for forming data which causes an LED and a liquid crystal panel to drive in accordance with an input image (hereinafter, such circuit is referred to as a local dimming driving circuit). In consideration of a difference in resolution between an LED backlight and the liquid crystal panel, the local dimming driving circuit determines, per divisional area, an amount of light emitted from the LED and transmittance of the liquid crystal in accordance with an input image.

The amount of light emitted from the LED is controlled to be smaller with respect to a dark area of the input image and to be larger with respect to a bright area thereof. Transmittance of the liquid crystal is adjusted in accordance with the amount of the light emitted from the LED so that the display device obtains a desired luminance curve as a whole (γ is generally adjusted to satisfy 2.2).

FIG. 11 illustrates an operation in a case where an image 113 having a high APL is inputted to a local dimming type liquid crystal display device including a local dimming driving circuit. When the image 113 having a high APL is inputted to the local dimming liquid crystal display device, an amount of an LED driving current is limited by the operation of the protection circuit of the LED, and the amount of the light emitted from the LED is therefore reduced (as indicated by a reference sign 115 of FIG. 11). In this case, the luminance of the whole screen becomes lower than luminance originally supposed to be emitted.

In a case where a video signal adjustment function of an image processing engine (as indicated by reference sign 116 in FIG. 11) is used to improve the luminance of the image in order to solve such a drawback, a data signal to be supplied to the local dimming driving circuit is adjusted so that the luminance will be increased especially for halftones. As per the data signal, the local dimming driving circuit therefore attempts to increase the amount of the light emitted from the LED (as indicated by a reference sign 114 in FIG. 11). However, the amount of the LED driving current is limited by the protection circuit (as indicated by a reference sign 115 in FIG. 11). As a result, luminance of an image to be displayed cannot be increased (as indicated by a reference sign 117 in FIG. 11).

The present invention has been made in view of the aforementioned problem, and an object of the present invention is to provide a display device and a method for controlling display, each of which can prevent reduction in display luminance without causing an increase in amount of light emitted from a backlight.

### Solution to Problem

In order to attain the aforementioned object, a liquid crystal display device according to the present invention including (i) a liquid crystal display panel in which a plurality of pixels are arranged and (ii) an area-based control backlight section including a light emitting diode serving as a light source and being capable of adjusting an amount of light emitted from the area-based control backlight section, the liquid crystal display device, includes: a display data formation section for forming, on the basis of an input image signal, display data to display an image on the liquid crystal display panel; a backlight data formation section for forming, on the basis of the input image signal, backlight data to adjust the amount of the light of the area-based control backlight section; a protection section for limiting an amount of a driving current of the area-based control backlight section so that the amount of the driving current does not exceed a predetermined upper limit; and a display data correction section for correcting the display data formed in the display data formation section so as to compensate reduction in luminance of the backlight in a case where the amount of the driving current of the area-based control backlight section is reduced to the upper limit by the protection section.

According to the aforementioned arrangement, an area-based control backlight driving is carried out in such a manner that the display data formation section forms the display data on the basis of the input image signal, the backlight data formation section forms the backlight data, the display data causes the liquid crystal display panel to drive, and the backlight data causes the area-based control backlight section to drive. Further, the area-based control backlight section employs, as the light source, an LED which is likely to deteriorate due to heat. However, the amount of the driving current of the area-based control backlight section is limited by the protection section so as not to exceed the upper limit, and therefore such deterioration of the LED is prevented. However, in a case where the protection section limits the amount of the electric current of the backlight, luminance of the whole screen becomes lower than luminance which is originally supposed to be emitted.

In view of the circumstances, the display data correction section corrects the display data formed in the display data formation section to thereby increase the transmittance, so that the reduction in luminance of the backlight can be compensated. This makes it possible to prevent the reduction in the display luminance without causing an increase in amount of light emitted from a backlight.

Further, in order to attain the aforementioned object, the liquid crystal display device according to the present invention including (i) a liquid crystal display panel in which a plurality of pixels are arranged and (ii) an area-based control backlight section including a light emitting diode serving as a light source and being capable of adjusting an amount of light emitted from the area-based control backlight section, the liquid crystal display device, includes: a display data formation section for forming, on the basis of an input image signal, display data to display an image on the liquid crystal display panel; a backlight data formation section for forming, on the basis of the input image signal, backlight data to adjust the amount of the light of the area-based control backlight section; a display data correction section for increasing transmittance of a liquid crystal by (i) receiving luminance adjustment information from an outside of the liquid crystal display device and (ii) correcting, on the basis of the luminance adjustment information, the display data formed by the display data formation section.

According to the aforementioned arrangement, an area-based control backlight driving is carried out in such a manner that the display data formation section forms the display data on the basis of the input image signal, the backlight data formation section forms the backlight data, the display data causes the liquid crystal display panel to drive, and the backlight data causes the area-based control backlight section to drive. Further, the display data correction section corrects the display data on the basis of the luminance adjustment information to thereby increase the transmittance. This makes it possible to increase in display luminance without causing an increase in amount of light emitted from a backlight.

Further, in order to attain the aforementioned object, a method for controlling display of a liquid crystal display device according to the present invention, including (i) a liquid crystal display panel in which a plurality of pixels are arranged and (ii) an area-based control backlight section including a light emitting diode serving as a light source and being capable of adjusting an amount of light emitted from the area-based control backlight section, the liquid crystal display device, the method includes: a display data formation step for forming, on the basis of an input image signal, display data to display an image on the liquid crystal display panel; a backlight data formation step for forming, on the basis of the input image signal, backlight data to adjust the amount of the light of the area-based control backlight section; a protection step for limiting an amount of a driving current of the area-based control backlight section so that the amount of the driving current does not exceed a predetermined upper limit; and a display data correction step for correcting the display data formed in the display data formation step so as to compensate reduction in luminance of the backlight in a case where the amount of the driving current of the area-based control backlight section is reduced to the upper limit by the protection step.

Further, in order to attain the aforementioned object, a method for controlling display of another liquid crystal display device according to the present invention, including (i) a liquid crystal display panel in which a plurality of pixels are arranged and (ii) an area-based control backlight section including a light emitting diode serving as a light source and being capable of adjusting an amount of light emitted from the area-based control backlight section, the method includes: a display data formation step for forming, on the basis of an input image signal, display data to display an image on the liquid crystal display panel; a backlight data formation step for forming, on the basis of the input image signal, backlight data to adjust the amount of the light of the area-based control backlight step; and a display data correction step for increasing transmittance of a liquid crystal by (i) receiving luminance adjustment information from an outside of the liquid crystal display device and (ii) correcting, on the basis of the luminance adjustment information, the display data formed by the display data formation section.

### Advantageous Effects of Invention

As described above, a liquid crystal display device of the present invention including (i) a liquid crystal display panel in which a plurality of pixels are arranged and (ii) an area-based control backlight section including a light emitting diode serving as a light source and being capable of adjusting an amount of light emitted from the area-based control backlight section, the liquid crystal display device, includes: a display data formation section for forming, on the basis of an input image signal, display data to display an image on the liquid crystal display panel; a backlight data formation section for forming, on the basis of the input image signal, backlight data to adjust the amount of the light of the area-based control backlight section; a protection section for limiting an amount of a driving current of the area-based control backlight section so that the amount of the driving current does not exceed a predetermined upper limit; and a display data correction section for correcting the display data formed in the display data formation section so as to compensate reduction in luminance of the backlight in a case where the amount of the driving current of the area-based control backlight section is reduced to the upper limit by the protection section.

Therefore, the display data correction section corrects the display data formed in the display data formation section to thereby increase the transmittance, so that the reduction in luminance of the backlight can be compensated, which reduction is caused by the protection section. This makes it possible to prevent the reduction in the display luminance without causing an increase in amount of light emitted from a backlight.

Further, as described above, the liquid crystal display device according to another present invention including (i) a liquid crystal display panel in which a plurality of pixels are arranged and (ii) an area-based control backlight section including a light emitting diode serving as a light source and being capable of adjusting an amount of light emitted from the area-based control backlight section, the liquid crystal display device, includes: a display data formation section for forming, on the basis of an input image signal, display data to display an image on the liquid crystal display panel; a backlight data formation section for forming, on the basis of the input image signal, backlight data to adjust the amount of the light of the area-based control backlight section; a display data correction section for increasing transmittance of a liquid crystal by (i) receiving luminance adjustment information from an outside of the liquid crystal display device and (ii) correcting, on the basis of the luminance adjustment information, the display data formed by the display data formation section.

The display data correction section corrects the display data on the basis of the luminance adjustment information to thereby increase the transmittance. This makes it possible to increase the display luminance without causing an increase in the amount of the light emitted from the backlight.

### BRIEF DESCRIPTION OF DRAWINGS

FIG. 1 is a block diagram of a liquid crystal display device according to an example of the present invention.

FIG. 2 illustrates an operation of the liquid crystal display device of FIG. 1 in a case where an input image has a high APL.

FIG. 3 illustrates an operation of the liquid crystal display device of FIG. 1 in a case where an input image has a low APL.

FIG. 4 are explanatory views illustrating a method for limiting an amount of an electric current of an LED on the basis of LED data sent from an LED data calculation section; FIG. 4(a) is a graph showing a relationship between an APL of an input image and an amount of an output current of an LED power source; FIG. 4(b) is a graph showing an operation of an LED control section; and FIG. 4(c) is a graph showing an operation of a liquid crystal transmittance correction section.

FIG. 5 are explanatory views in which, in order to prevent generation of a clip, the transmittance is controlled on a high-tone side with use of a correction amount lower than a correction amount originally supposed to be emitted: FIG. 5(a) is a graph showing a case where characteristics indicated by (α) and (β) in FIG. 4(c) are corrected with use of a correction amount B; and FIG. 5(b) is a graph showing a case where the characteristics indicated by (α) and (β) in FIG. 4(c) are corrected with use of both the correction amount B and a correction amount lower than the correction amount B.

FIG. 6 is a block diagram illustrating a liquid crystal display device according to an embodiment of the present invention, in which feedforward control is carried out.

FIG. 7 is a block diagram of a liquid crystal display device according to another embodiment of the present invention.

FIG. 8 is a block diagram of a liquid crystal display device according to still another embodiment of the present invention.

FIG. 9 are explanatory views each illustrating an operation of a conventional liquid crystal display device; FIG. 9(a) illustrates a case where an input image has a low APL; and FIG. 9(b) illustrates a case where an input image has a high APL.

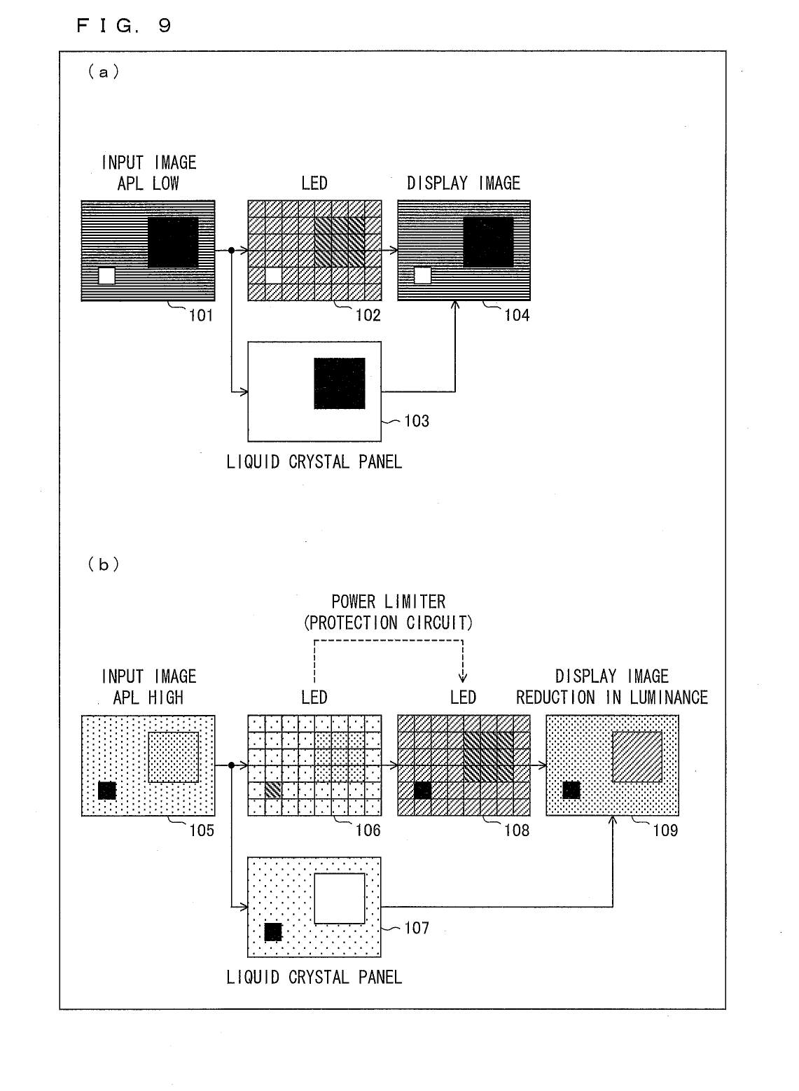

FIG. 10 are explanatory views of a conventional liquid crystal display device in which inputted image data is subjected to gain processing on the basis of an LUT of a signal processing circuit; FIG. 10(a) is a block diagram of the conventional liquid crystal display device in which the inputted image data is subjected to the gain processing on the basis of the LUT of the signal processing circuit; FIG. 10(b) is a graph showing an input-output characteristic when the gain processing is carried out on the basis of the LUT; and FIG. 10(c) is a graph showing a characteristic of output luminance with respect to the inputted image data.

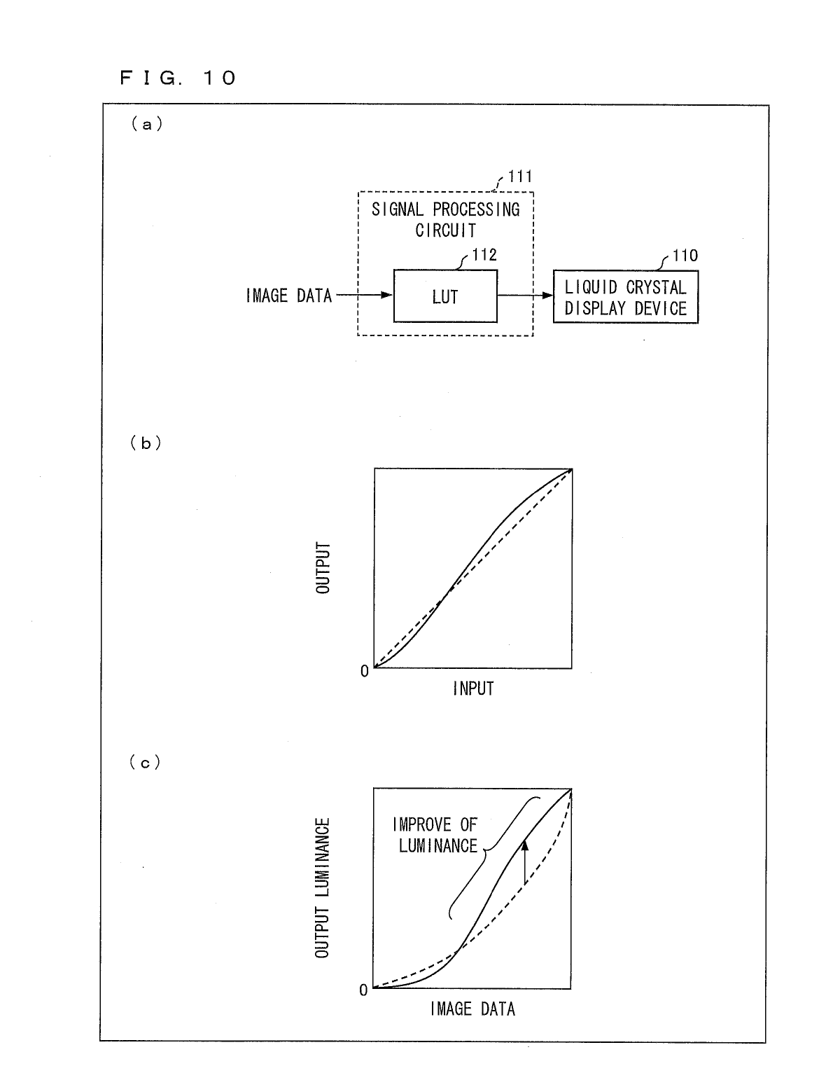

FIG. 11 illustrates an operation in a case where a conventional liquid crystal display device including a local dimming driving circuit receives an image having a high APL.

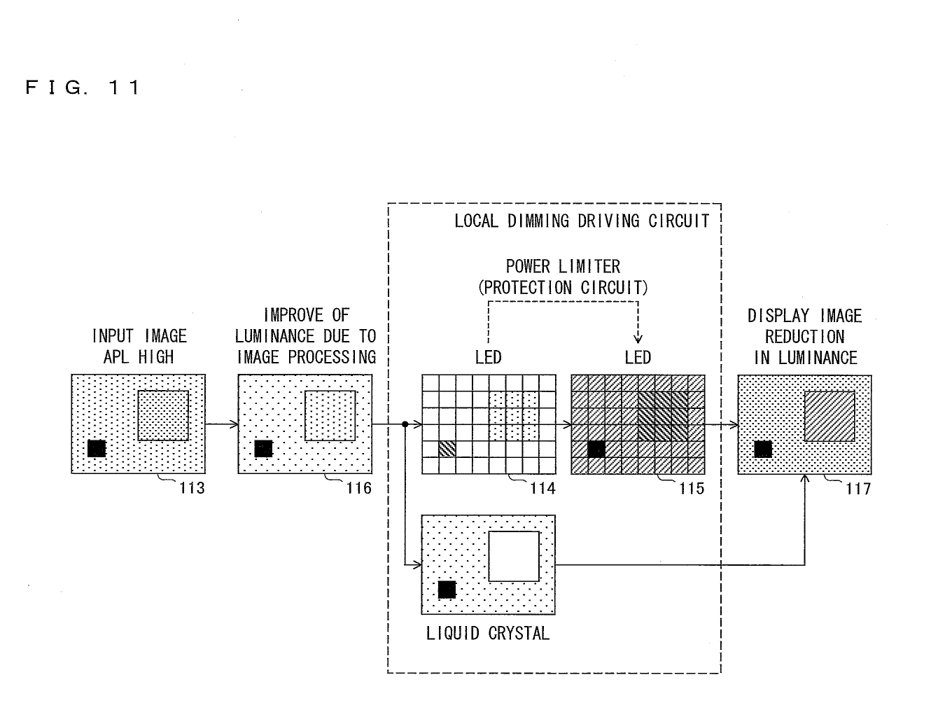

### DESCRIPTION OF EMBODIMENTS

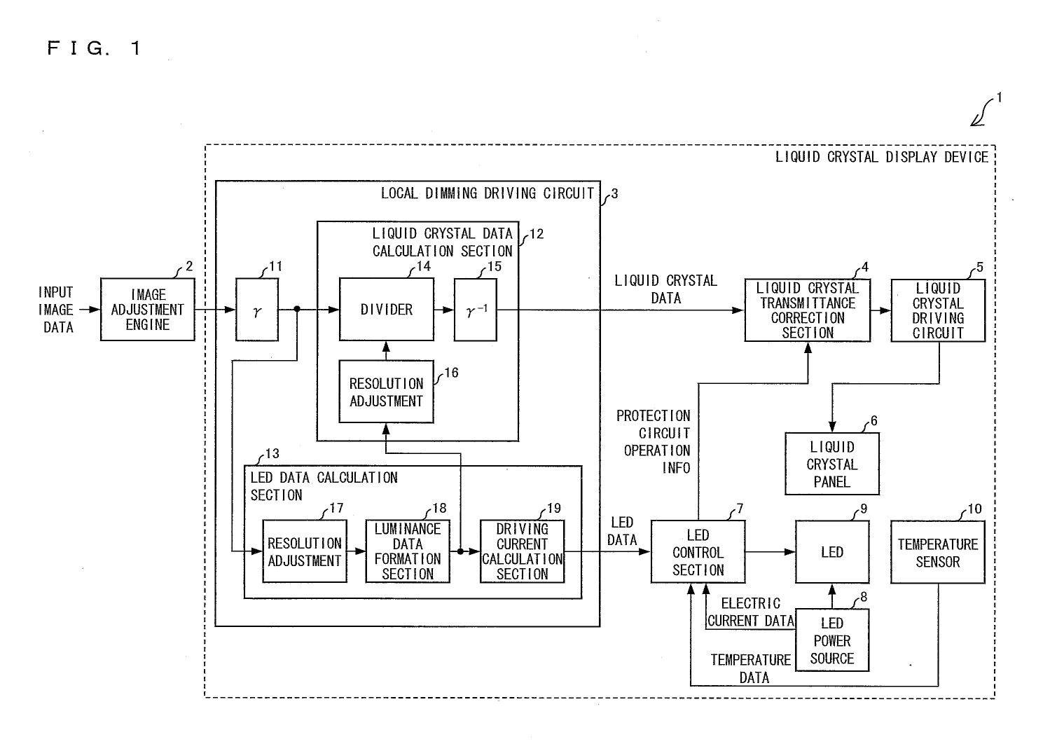

Embodiments (Examples 1 to 3) of the present invention will be described below with reference to FIGS. 1 to 7.

### Example 1

FIG. 1 is a block diagram of a liquid crystal display device 1 according to Example 1. The liquid crystal display device 1 includes a local dimming driving circuit 3 (backlight data formation section, display data formation section), a liquid crystal transmittance correction section 4 (display data correction section), a liquid crystal driving circuit 5, a liquid crystal panel 6 (liquid crystal display panel), an LED control section 7, an LED power source 8, an LED backlight 9 (area-based control backlight section, area-based control backlight), and a temperature sensor section 10. An image adjustment engine 2 is provided to be followed by the liquid crystal display device 1 in this example, however, the image adjustment engine 2 may be provided inside the liquid crystal display device 1 instead. A plurality of pixels are arranged in the liquid crystal panel 6, the LED backlight 9 includes a plurality of LEDs (light emitting diodes), and the temperature sensor section 10 includes a plurality of temperature sensors. The LED power source 8 supplies an electric current to the plurality of LEDs.

The local dimming driving circuit 3 includes a γ transform section 11, a liquid crystal data calculation section 12, and an LED data calculation section 13. The local dimming drive means (i) dividing a display area of the liquid crystal panel 6 into a plurality of areas and (ii) controlling an intensity of light emitted from the LEDs, which intensity corresponds to each area, in accordance with luminance of an input image for each area.

An LED is generally used in a light source of a backlight section of the liquid crystal display device in which the local dimming drive is carried out so as to adjust luminance for each area. In a case where the LED is used in the light source, a protection function (protection section) of setting an upper limit (upper limit value) of the amount of the electric current flowing through the LED is provided in order to prevent the LED from deteriorating due to heat. For this reason, the present invention is suitably used for local dimming drive, so that this example exemplifies the liquid crystal display device in which the local dimming drive is carried out. Note that the local dimming drive is not always necessary for the present invention, and the present invention is applicable to a liquid crystal display device in which an LED in a backlight source is used and an amount of an electric current is limited for protecting the LED.

The liquid crystal data calculation section 12 includes a divider 14, a γ inverse transform section 15, and a resolution adjustment section 16. The LED calculation section 13 includes a resolution adjustment section 17, a luminance data formation section 18, and a driving current calculation section 19.

An input image data signal (input image signal) is subjected to image quality adjustment, such as hue adjustment, luminance adjustment, chroma adjustment, edge enhancement, and noise reduction, by the image adjustment engine 2. The image data signal, which has been subjected to the image quality adjustment, is outputted to the local dimming driving circuit 3 of the liquid crystal display device 1.

Liquid crystal data (display data) and LED data (backlight data) to display an image on the liquid crystal panel 6 are formed in the local dimming driving circuit 3 on the basis of the image data signal subjected to the image quality adjustment. The LED data is formed by obtaining the amount of the light emitted from the LED of the LED backlight 9 for each predetermined display area.

The local dimming driving circuit 3 mainly includes the γ transform section 11, the LED data calculation section 13, and the liquid crystal data calculation section 12. First, the image data signal supplied to the local dimming driving circuit 3 is transformed into an optically linear space through γ transform of the γ transform section 11. The image data thus subjected to the γ transform is sent to the LED data calculation section 13 and the liquid crystal data calculation section 12.

There is a difference between resolution of the liquid crystal panel 6 and resolution of the numbers of divisional areas of the LED backlight 9, so that the resolution adjustment section 17 of the LED data calculation section 13 adjusts resolution to the numbers of the divisional areas of the LED backlight 9 by down-sampling the image data signal subjected to the γ transform. The luminance data formation section 18 forms LED luminance data (i.e., luminance data of light emitting element) on the basis of the image data signal thus down sampled. That is, the luminance of the whole display system is mainly formed on the backlight 9 side. Specifically, the luminance of the LED decreases as the APL of the input image becomes lower, and in contrast, the luminance of the LED increases as the APL of the input image data becomes higher.

The LED luminance data formed in the luminance data formation section 18 is transformed, in the driving current calculation section 19, into a signal for actually driving the LED backlight 9. At the same time, the LED luminance data is sent to the resolution adjustment section 16 of the liquid crystal data calculation section 12.

The resolution adjustment section 16 of the liquid crystal data calculation section 12 re-adjusts the LED luminance data, which has been sent from the LED data calculation section 13. The readjustment causes the LED luminance data to be suitable for the resolution of the liquid crystal panel 6. The divider 14 divides the image data signal, which has been subjected to the γ transform, by the LED luminance data, which is subjected to the resolution adjustment. The γ inverse transform section 15 carries out γ inverse transform with respect to data outputted from the divider 14, and then outputs, to the liquid crystal transmittance correction section 4, the data serving as the liquid crystal data.

The LED data is outputted from the LED data calculation section 13 of the local dimming driving circuit 3, and is then sent to the LED control section 7. The LED control section 7 practically controls to lighten the plurality of LEDs of the LED backlight 9 on the basis of the LED data thus sent.

The LED control section 7 includes the protection function of preventing the LED of the LED backlight 9 from deteriorating due to heat. Specifically, in a case where the LED emits light to thereby generate heat and a temperature of the LED itself exceeds a predetermined level, light emitting efficiency of the LED is reduced, and in addition, lifetime and reliability of the LED serving as a device are badly affected. The LED control section 7 limits the amount of the electric current which is to supply to the LED, and prevents temperature of the LED from increasing over a predetermined temperature.

On the basis of the LED data sent from the LED data calculation section 13, the protection of the LED, i.e., limitation of the amount of the electric current is carried out, basically in a case where (i) an image inputted to the liquid crystal display device 1 has a high APL and (ii) the amount of the electric current of the LED power source 8 exceeds a predetermined threshold unless the amount of the electric current is limited. In order to protect the LED power source 8 from an overcurrent, the LED control section 7 controls the amount of the electric current of the LED power source 8 so that the amount of the electric current of the LED power source 8 does not exceed the threshold when the LED data indicates a value higher than the predetermined threshold. Limitation of the amount of the electric current of the LED power source 8 is carried out by a protection circuit (power limiter) included in the LED power source 8.

Further, the temperature sensor 10 obtains temperature data of the LED backlight 9 serving as a module. The LED can be protected not only on the basis of the LED data sent from the LED data calculation section 13 but also on the basis of the temperature data sent from the temperature sensor section 10.

Such functional operation for protecting LED causes the LED control section 7 to appropriately limit the LED data sent from the local dimming driving circuit 3, so that the LED control section 7 controls the light emitted from the LED whereas the luminance of the LED is reduced. Simultaneously with such control of the light emitted from the LED, the liquid crystal transmittance correction section 4 receives from the LED control section 7 information relating to the control of the light emitted from the LED, which is protection circuit operation information included in the LED control section 7.

The liquid crystal transmittance correction section 4 corrects the liquid crystal data obtained in the local dimming driving circuit 3 in accordance with the protection circuit operation information (driving current information). In other words, the liquid crystal transmittance correction section 4 corrects transmittance of each pixel of the liquid crystal panel 6. In a case where an amount of a driving current of the LED backlight 9 is reduced to an upper limit by the protection function, the liquid crystal transmittance correction section 4 corrects the liquid crystal data formed in the local dimming driving circuit 3 so as to compensate reduction in luminance of the backlight. The protection circuit operation information can be defined by a ratio of (i) an actual amount of the electric current indicated by LED driving output data which is supplied from the LED control section 7 to (ii) an original amount of the electric current indicated by the LED data which is supplied from the local dimming driving circuit 3. Alternatively, the protection circuit operation information may be defined by a ratio of (i) a DUTY ratio of PWM (pulse width modulation) indicated by the LED data which is supplied from the local dimming driving circuit 3 to (ii) a DUTY ratio of an actual LED driving output data which is supplied from the LED control section 7.

A current supplied to LED-luminance characteristic or a DUTY ratio of PWM-luminance characteristic is generally adjusted to satisfy γ=1, i.e., a proportional relationship. For example, in a case where a ratio indicated by the protection circuit operation information is 90%, the luminance of the LED is reduced by 10% from luminance indicated by the LED data.

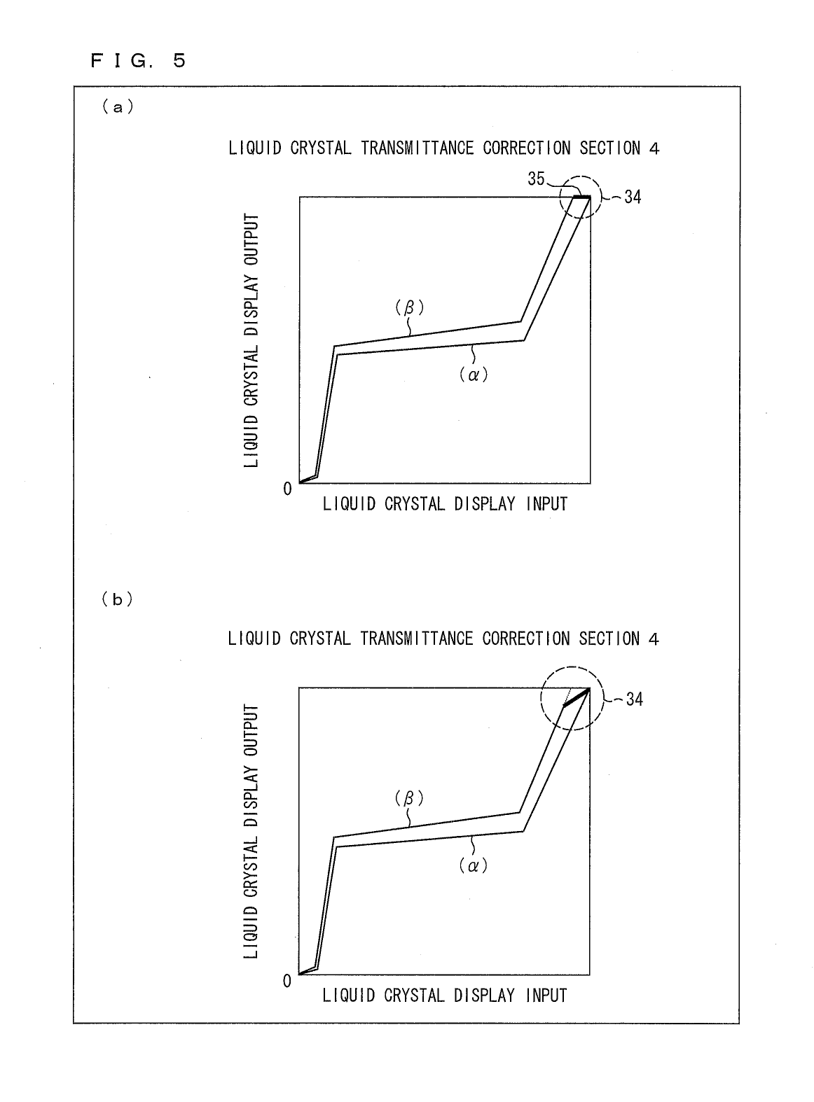

In order to compensate the reduction in luminance of the LED, the liquid crystal transmittance correction section 4 corrects the liquid crystal data so as to increase transmittance of the liquid crystal panel 6. Since the reduction in luminance of the LED is 10% in the aforementioned example, a transmittance curve of the liquid crystal of the liquid crystal panel 6 is corrected. In this way, the transmittance of the liquid crystal panel 6 is corrected to be increased by 10%. Note that, when lifting the transmittance curve simply, a clip is generated (i.e., a state in which the transmittance is saturated is generated in a continuous tone range because the transmittance attempts to exceed maximum transmittance and then is reduced to the maximum transmittance: see FIG. 5(a)) on a high-tone side. Accordingly, the transmittance curve is desirably corrected so that the transmittance is gradually saturated in the vicinity of the high-tone side. Note that, when an input image has a high APL (average picture level), the luminance of the LED data is averagely brightened and the transmittance of the liquid crystal data (LCD data) is averagely lowered by the local dimming driving circuit 3. Therefore, the clip generated on the high-luminance side does not causes any problem in most cases. Note that the reason why the transmittance of the liquid crystal data is low when an input image has a high APL is as follows.

First, in the local dimming type liquid crystal display device, the input image, which has been subjected to γ transform, is subjected to down sampling for each divisional area so as to adjust resolution of the input image to resolution of the LED (FIG. 1, resolution adjustment section 17), and then the LED luminance data is formed (FIG. 1, luminance data formation section 18). Next, the input image subjected to the γ transform is divided by the LED data whose resolution has been re-adjusted to the resolution of the liquid crystal (FIG. 1, resolution adjustment section 16), and is then subjected to γ inverse transform. In this way, the liquid crystal data is obtained.

In a case where an image has a high APL (bright and high luminance as a whole), the LED luminance data formed in the luminance data formation section 18 becomes large value, so that the liquid crystal data which is a calculation result in the divider 14 becomes small value (low transmittance).

The liquid crystal data, which has been corrected in the liquid crystal transmittance correction section 4, is displayed on the liquid crystal panel 6 by the liquid crystal driving circuit 5. The liquid crystal panel 6 and the LED backlight 9 having the controlled luminance are combined with each other, which in turn reproduce the input image data.

An operation of the liquid crystal display device according to Example 1 will be described below in more detail.

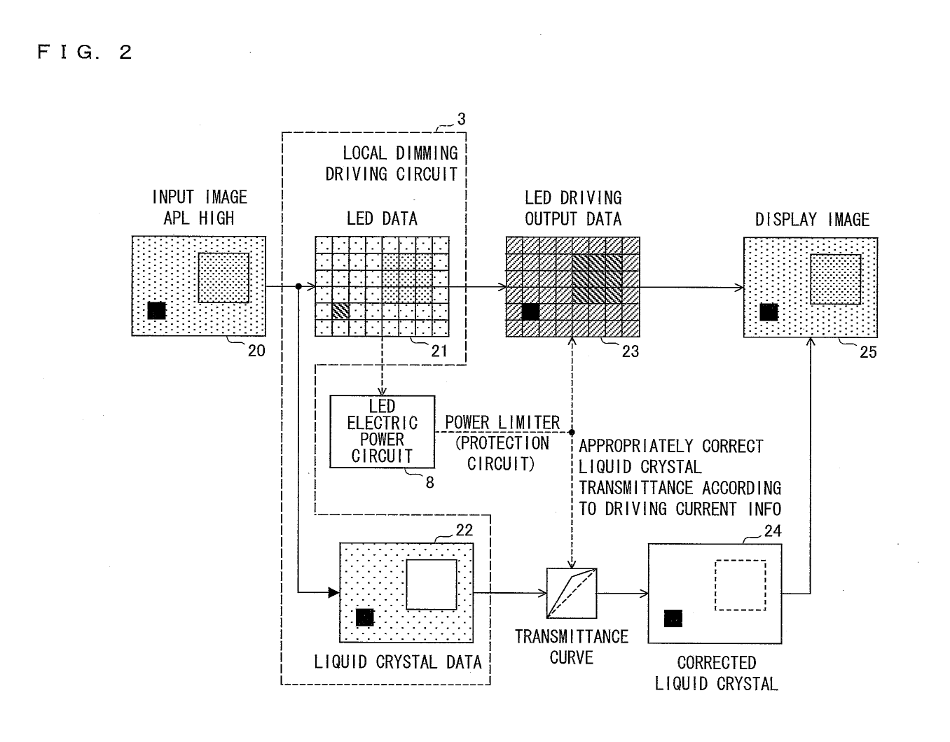

FIG. 2 illustrates an operation of the liquid crystal display device 1 in a case where the amount of the electric current of the LED is limited because the input image has a high APL. The local dimming driving circuit 3 forms both LED data 21 and liquid crystal data 22 based on data of an input image 20 whose image quality has been appropriately adjusted, as necessary, when the APL is high.

The LED data 21 is sent to the LED control section 7, and the LED control section 7 forms LED driving output data 23 based on the LED data 21 thus sent. Then the LED driving output data 23 is outputted to the LED backlight 9. In this way, lightening of the LED backlight 9 is carried out under control.

In order to protect the LED power source 8 from overcurrent, the amount of the electric current of the LED power source 8 is limited by the protection circuit of the LED power source 8 when the amount of the electric current of the LED power source 8 exceeds a predetermined threshold. Therefore, in a case where the amount of the electric current of the LED power source 8 is limited, the LED driving output data 23 is corrected. The LED driving output data 23 thus corrected has luminance lower than the LED data 21.

The transmittance of the liquid crystal data 22 obtained in the local dimming driving circuit 3 is appropriately corrected in the liquid crystal transmittance correction section 4 in accordance with the protection circuit operation information (driving current information). The liquid crystal data 22 thus corrected becomes corrected liquid crystal data 24.

The corrected liquid crystal data 24 and the LED driving output data 23 thus corrected are combined with each other to thereby reproduce finally the input image data to be displayed as a display image 25.

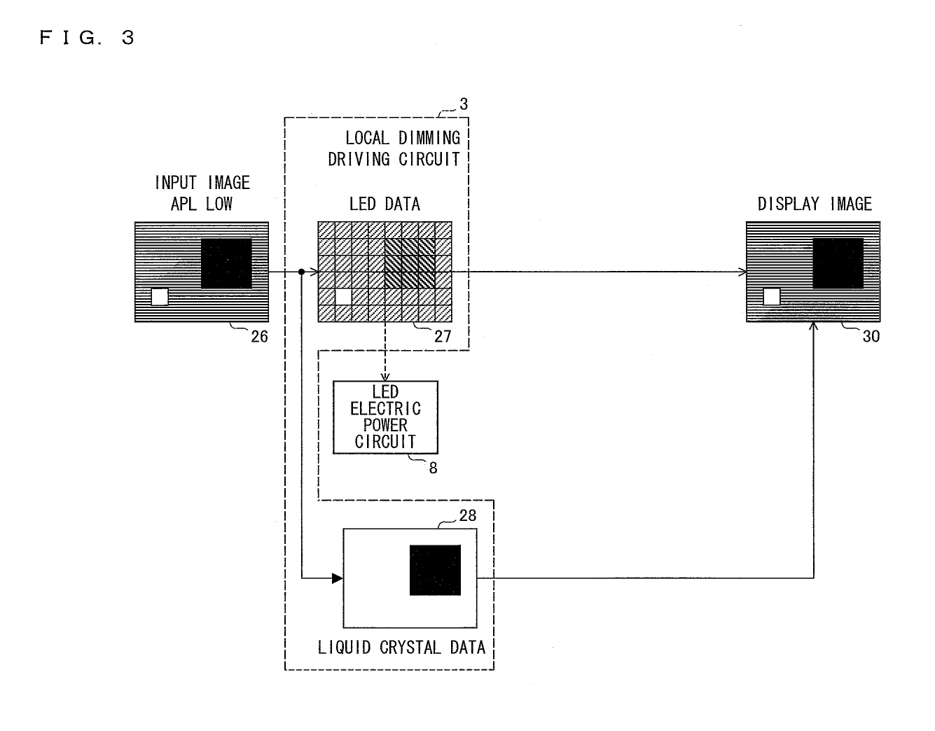

FIG. 3 illustrates an operation of the liquid crystal display device 1 in a case where the amount of the electric current of the LED is not limited because the input image has a low APL. The local dimming driving circuit 3 forms both LED data 27 and liquid crystal data 28 based on data of an input image 26 whose image quality has been appropriately adjusted, as necessary, when the APL is low.

The LED data 27 is sent to the LED control section 7, and the LED control section 7 outputs to the LED backlight 9 LED driving output data based on the LED 27 thus sent. In this way, lightening of the LED backlight 9 is carried out under control.

At this time, the amount of the electric current of the LED power source 8 is not limited by the protection circuit of the LED power source 8 because the amount of the electric current of the LED power source 8 does not exceed a predetermined threshold. Therefore, the LED control section 7 outputs as the LED driving output data the LED data 27 without any changes.

In a case where the amount of the electric current of the LED power source 8 is not limited, the liquid crystal transmittance correction section 4 does not correct the liquid crystal data 28. Therefore, the liquid crystal transmittance correction section 4 outputs the liquid crystal data 28 to the liquid crystal driving circuit 5 in such a way that the liquid crystal data 28 that the local dimming driving circuit 3 has obtained is supplied as such to the liquid crystal driving circuit 5. Accordingly, the liquid crystal data 28 and the LED driving output data are combined to reproduce finally the input image data displayed as a display image 30.

Next, a method for limiting the amount of the electric current of the LED on the basis of the LED data sent from the LED data calculation section 13 will be described.

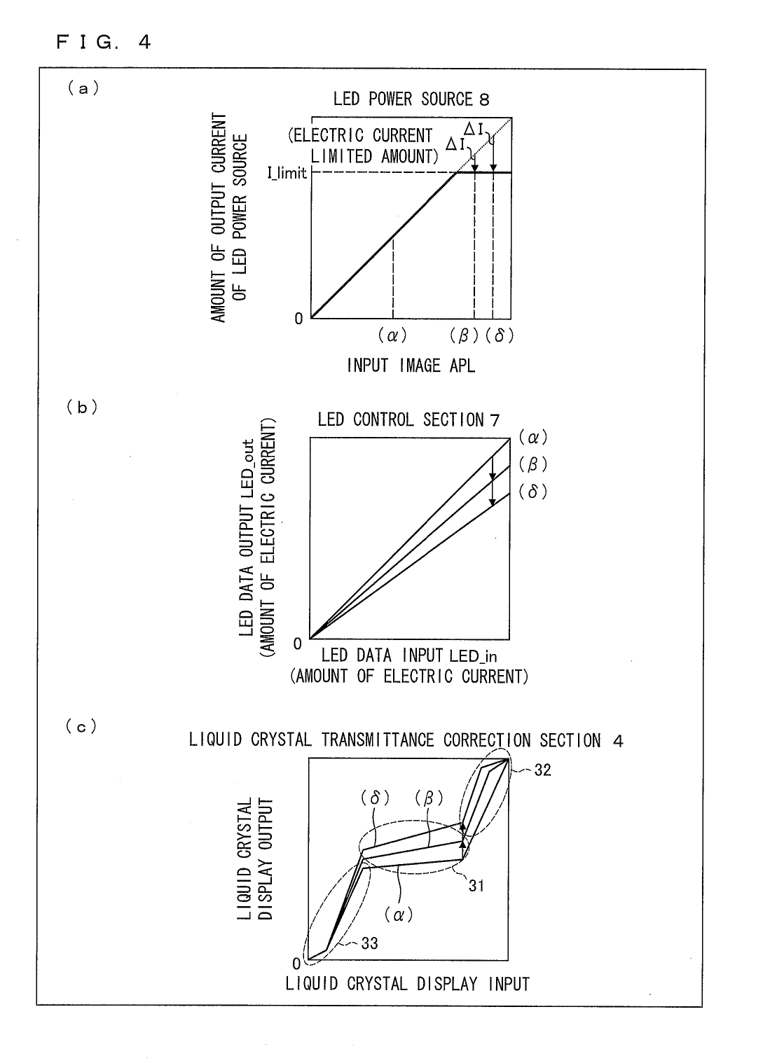

FIG. 4 are explanatory views illustrating a method for limiting the amount of the electric current of the LED on the basis of the LED data sent from the LED data calculation section 13. In FIGS. 4(a) to 4(c), (α) shows a state in which an amount of an output current of the LED power source 8 is not limited because an APL of the input image is low. Further, (β) and (δ) each show a state in which an amount of an output current of the LED power source 8 is limited because an APL of an input image is high. The amount of the electric current is limited more in the state of (δ) than the state of (β) because the APL is higher in the state of (δ) than the state of (β). Note that (α), (β), and (δ) in FIG. 4(a) correspond to (α), (β), and (δ) in each of FIGS. 4(b) and 4(c).

FIG. 4(a) is a graph showing a relationship between the APL of the input image and the amount of the output current of the LED power source 8. In a case where the APL of the input image is low as shown in (α) of FIG. 4(a), the amount of the output current of the LED power source 8 is equal to or lower than an electric current limited amount I_limit. Accordingly, the amount of the output current is not limited.

Meanwhile, the amount of the electric current for lighting the LED is increased as the APL of the input image is increased. Consequently, the amount of the output current reaches and becomes equal to the electric current limited amount I_limit ((β) and (δ) of FIG. 4(a)). A difference ΔI, which is generated between the electric current limited amount I_limit and the amount of the electric current originally supposed to be supplied, becomes larger in the state of (δ) than in the state of (β) because (δ) has a higher APL than (β).

As illustrated in FIG. 4(b), the LED control section 7 is operated in accordance with output current amount information received from the LED power source 8. More specifically, the LED control section 7 reduces an output LED_out of the LED data (with respect to an input LED_in of the LED data) from (α) to (δ) in this order in FIG. 4(b) as the APL of the input image is increased from (α) to (δ) in this order in FIG. 4(a). Note that the LED data is outputted as indicated by the characteristic of (α) illustrated in FIG. 4(b) as long as the amount of the output current of the LED power source 8 in FIG. 4(a) does not exceed the electric current limited amount I_limit.

Further, the input LED_in of the LED data and the output LED_out of the LED data satisfy the following equations (1) and (2).

LED_out=A·LED_in (1)

A=I_limit/(I_limit+ΔI) (2)

As described above, the amount of the light emitted from the backlight with respect to the whole screen is adjusted in accordance with the APL of the input image. Therefore, it can be prevented that only a part of the screen becomes unnaturally dark in comparison with the other parts of the screen, even in a case where the amount of the output current is limited by the LED power source 8 because an APL of the input image is high. In addition, it can be also prevented that a part having an APL equal to or lower than the electric current limited amount I_limit of the LED power source 8 becomes unnaturally bright.

However, since the luminance of the LED is in proportion to the amount of the driving current of the LED, the luminance of the whole screen is reduced to luminance of A×1/100[%] when the LED control section 7 is controlled as illustrated in FIG. 4(b), in comparison with a case where the output current is not limited.

In view of the circumstances, the present invention compensates the luminance for (i) the reduction from (α) to (β) in the LED control section 7 and (ii) the reduction from (α) to (δ) in the LED control section 7 by correcting the transmittance (FIG. 4(c)) with use of the liquid crystal transmittance correction section 4. This offsets reduction in the luminance of the LED backlight 9.

FIG. 4(c) shows a liquid crystal data input-liquid crystal data output characteristic (transmittance curve) which is applicable to correction carried out by the liquid crystal transmittance correction section 4. How to define the transmittance curve will be described below.

First, in this example, the transmittance of the liquid crystal transmittance correction section 4 is corrected so as to compensate the luminance in consideration of a voltage-luminance characteristic of the liquid crystal panel 6 including the liquid crystal driving circuit 5. The voltage-luminance characteristic is generally adjusted to satisfy γ=2.2. Accordingly, an input and an output of the transmittance curve shown in FIG. 4(c) are not in proportion to each other, and the transmittance curve is a curve including γ correction.

It is possible for the local dimming type liquid crystal display device to form a tone based on the luminance of the backlight (LED) and a tone based on the transmittance of the liquid crystal. In a case where the LED backlight and the liquid crystal panel have resolution of equal level, a tone of the input image can be reproduced only by keeping a tone of the liquid crystal (transmittance of the liquid crystal) constantly and controlling the luminance of the LED. The transmittance of the liquid crystal may be always set to 100%.

However, an LED backlight of an actual display device has lower resolution than the liquid crystal panel. Accordingly, when the transmittance of the liquid crystal is set to be completely constant, an input image containing a high-frequency component cannot be reproduced. It is therefore necessary to change the transmittance of the liquid crystal.

Further, there is a difference between the resolution of the LED backlight and the resolution of the liquid crystal panel. Therefore, in a case where the liquid crystal data is divided by the LED data in the divider 14 of the liquid crystal calculation section 12, a division result sometimes exceeds one because the LED data does not include a high-frequency component. In this case, the aforementioned setting requires the transmittance of the liquid crystal to exceed 100%. To give a simple example, in case of a pattern in which white display of a small area exists in black display, LED data having low resolution is recognized as gray. When a value of white (liquid crystal data) is divided by a value of gray (LED data), a division result exceeds 1.

The transmittance of the liquid crystal cannot exceed 100% practically. In order that the liquid transmittance may not exceed 100%, an region defined by a center section 31 of FIG. 4(c) has an imaginary transmittance of 100% and a substantially constant tone of the liquid crystal is set to be relatively low. The luminance of the whole display device when the region defined by the center section 31 has the imaginary transmittance of 100% is more reduced than the luminance of the whole display device when a region defined by the center section 31 has the actual transmittance of 100%. Further, a region defined by a right end section 32 of FIG. 4(c), i.e., the high-tone side is dealt with as a region in which the imaginary transmittance exceeds 100%, and is controlled on the basis of both a correction amount B and a correction amount lower than the correction amount B. Specifically, the tone is controlled to prevent visually unnatural luminance and curve of color.

Meanwhile, the LED data on a low-tone side does not become zero because there is a difference between resolutions, except for a case where only black is constantly inputted. It is therefore necessary that, in order to reproduce a dark area tone, the transmittance of the liquid crystal is set to be low in a region defined by a left end section 33 of FIG. 4(c). For example, consider a case where the luminance of the LED becomes a maximum luminance. In this case, when a part of the dark area tone exists in an area other than an area corresponding to the maximum luminance of the input image, the part of the dark area tone cannot be reproduced in the display image unless the transmittance of the liquid crystal is set to be remarkably low.

The reason why the LED data having low resolution becomes gray in a case of the pattern in which the white display of the small area exists in the black display as described above will be described below. When the LED luminance data having low resolution is formed from input image data having high resolution, a high frequency component of a signal is reduced and maximum luminance information in an input data is lost if general sampling is carried out through signal processing (e.g., data is reduced after the signal processing is carried out by low pass filter). Therefore, a peak of the luminance of an final output image may be lost.

Accordingly, in a case where some parts having the maximum luminance exist in an area of the LED (or in the display image) for carrying out the sampling, the maximum data may serve as the LED luminance data without carrying out the general sampling. Note that using the maximum luminance as the LED luminance data may cause (i) a risk in that a high-luminance minute noise included in the input data has an adverse effect on an output or (ii) an increase in consumption power. Accordingly, in a case where the LED luminance data is actually formed from the input data, the general sampling is basically used, and the maximum luminance is appropriately used as necessary depending on an input image. The maximum luminance (white) is therefore not always used as the LED luminance data.

Note that transmittance with respect to a data input LCD_dat of the liquid crystal panel is indicated by f(LCD_dat), a liquid crystal data input which is inputted to the liquid crystal transmittance correction section 4 is indicated by LCD_in, and liquid crystal data output is indicated by LCD_out. The liquid crystal data input LCD_in and the liquid crystal data output LCD_out satisfy the following equations (3) and (4). Note that B indicates the correction amount.

LCD_out=f⁻¹{B·f(LCD_in)} (3)

B=1/A (4)

Note that the clip is generated on the high-tone side if the equations (3) and (4) are simply used for the correction. It is therefore desirable that, in order to prevent generation of the clip, the transmittance is controlled with use of a correction amount lower than the original correction amount B on the high-tone side. This control will be described below with reference to FIG. 5.

FIG. 5 are explanatory views in which, in order to prevent generation of a clip, the transmittance is controlled on the high-tone side with use of a correction amount lower than the original correction amount B. FIG. 5(a) is a graph showing a case where characteristics indicated by (α) and (β) are corrected with use of only the correction amount B in FIG. 4(c). The liquid crystal transmittance correction section 4 of FIG. 5(a) corrects the transmittance without use of the correction amount lower than the correction amount B in a case of a characteristic indicated by (β), so that a clip 35 is generated in a part defined by a reference sign 34 on the high-tone (high-frequency) side.

FIG. 5(b) is a graph showing a case where the characteristics indicated by (α) and (β) in FIG. 4(c) are corrected with use of both the correction amount B and a correction amount lower than the correction amount B. The liquid crystal transmittance correction section 4 of FIG. 5(b) corrects the transmittance with use of both the correction amount B and the correction amount lower than the correction amount B in a case of the characteristic indicated by (β), so that the clip 35 is not generated in the part defined by the reference sign 34.

The method for limiting the amount of the electric current of the LED on the basis of the LED data sent from the LED data calculation section 13 has been described with reference to FIGS. 4 and 5. As described above, however, the amount of the electric current of the LED can be limited on the basis of the LED data and the temperature data sent from the temperature sensor section 10.

In a case of providing the temperature sensor section 10 as illustrated in FIG. 1, the temperature sensor section 10 inputs, to the LED control section 7, the temperature data of the LED backlight 9. The LED control section 7 can be arranged such that, when the temperature data supplied to the temperature sensor section 10 exceeds a predetermined setting level, the LED control section 7 reduces, to an electric current limited amount, the amount of the electric current supplied to the LED so as to prevent increase in temperature of the LED. In a case where the LED control section 7 limits the amount of the electric current supplied to the LED, processing similar to the processing described with reference to FIGS. 4 and 5 may be carried out. Note that, in a case where the amount of the electric current of the LED is limited by the temperature data thus actually measured, the amount of the electric current of the LED power source 8 does not need to be reduced to the electric current limited amount unless the temperature data of the temperature sensor section 10 exceeds the setting level even if the amount of the output current of the LED data sent to the LED control section 7 from the LED calculation section 13 exceeds the electric current limited amount I_limit.

Further, the description with reference to FIGS. 4 and 5 has been described in no consideration of the local dimming drive, and the aforementioned control can also be carried out with respect to all input images inputted to the liquid crystal display device 1. In a case where the local dimming drive is carried out, however, the aforementioned control may be carried out for each LED divisional area in the backlight. In this case, the amount of the electric current is locally limited for the each LED divisional area.

As described above, when an image having a high APL is inputted to the aforementioned liquid crystal display device 1, the liquid crystal display device 1 carries out feedback control so as to correct the transmittance in such a manner that the transmittance of the liquid crystal panel is increased as the amount of the driving current of the LED is reduced by the LED power source etc. However, the present invention is not limited to the aforementioned feedback control, and the following feedfoward control can be employed.

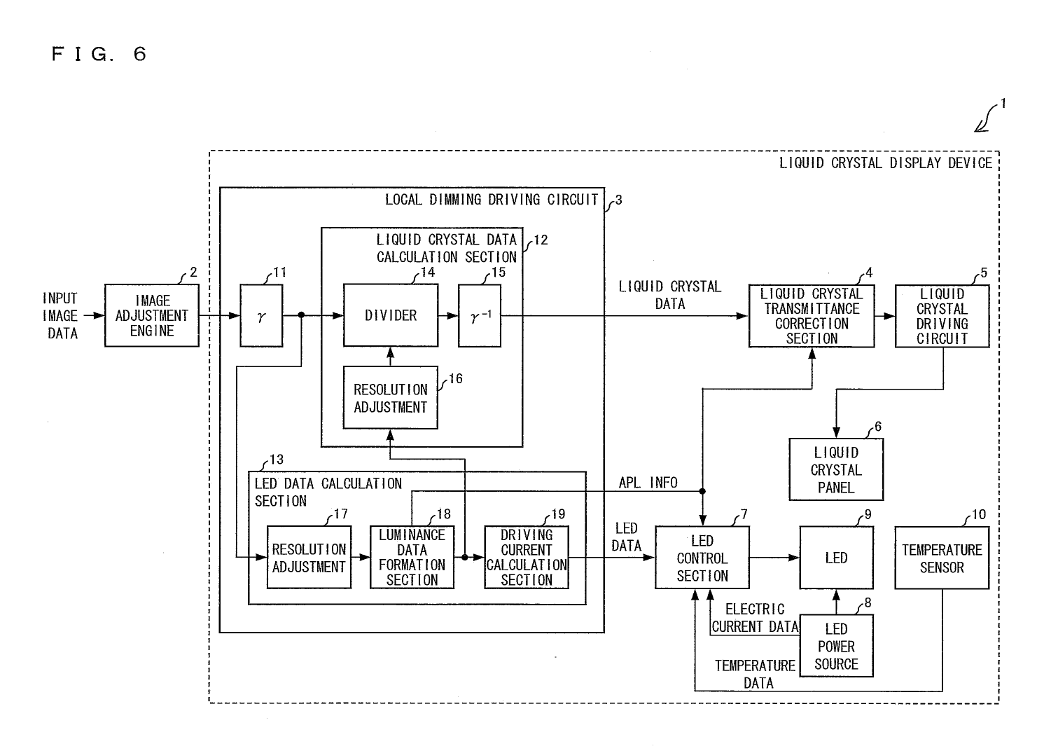

In a case of the feedfoward control as illustrated in FIG. 6, an APL of an input image data is calculated. When the APL thus calculated exceeds a reference value, APL information for indicating that the APL exceeds the reference value is sent to the liquid crystal transmittance correction section 4 and the LED control section 7. On the basis of the APL information thus sent, the liquid crystal transmittance correction section 4 and the LED control section 7 controls the amount of the electric current and corrects the transmittance in the same way as the feedback control.

In the feedforward processing, the liquid crystal transmittance correction section 4 and the LED control section 7 carry out their processing on the basis of the same APL information. This makes it possible to adjust and harmonize the processing of the liquid crystal transmittance correction section 4 and processing of the LED control section 7 so that the display image of the liquid crystal panel 6 is correctly reproduced on the basis of the input image data signal if the LED control section 7 does not notify the liquid crystal transmittance correction section 4 of the protection circuit operation information.

Note that the liquid crystal transmittance correction section 4 and the LED control section 7 may adjust the correction amount of the LED data output and the correction amount of the liquid crystal data output, respectively, in accordance with information, e.g., how much the calculated APL exceeds the reference value.

In the feedfoward control, the APL can be calculated in the luminance data formation section 18 (APL calculation means). When digital processing is carried out, the APL can be generally calculated from the following equation (5). Note that H represents the number of horizontal pixels for one screen, V represents the number of vertical pixels for one screen, and Y (i, j) represents luminance value in coordinate (i, j), and an average luminance for one screen can be calculated from the equation (5).

APL=1/(H×V)×ΣY(i,j) (5)

The APL is calculated from the equation (5) generally with use of a digital pixel value which is not subjected to the γ transform yet. In the liquid crystal display device 1 of FIG. 1, the image data signal subjected to the resolution adjustment is subjected to the γ transform in the γ transform section 11 of the local dimming driving circuit 3, and hence, in a case where an APL is calculated in the luminance data formation section 18 of FIG. 1, the signal supplied to the luminance data formation section 18 from the resolution adjustment section 17 needs to be returned by the γ inverse transform (gamma inverse transform).

### Example 2

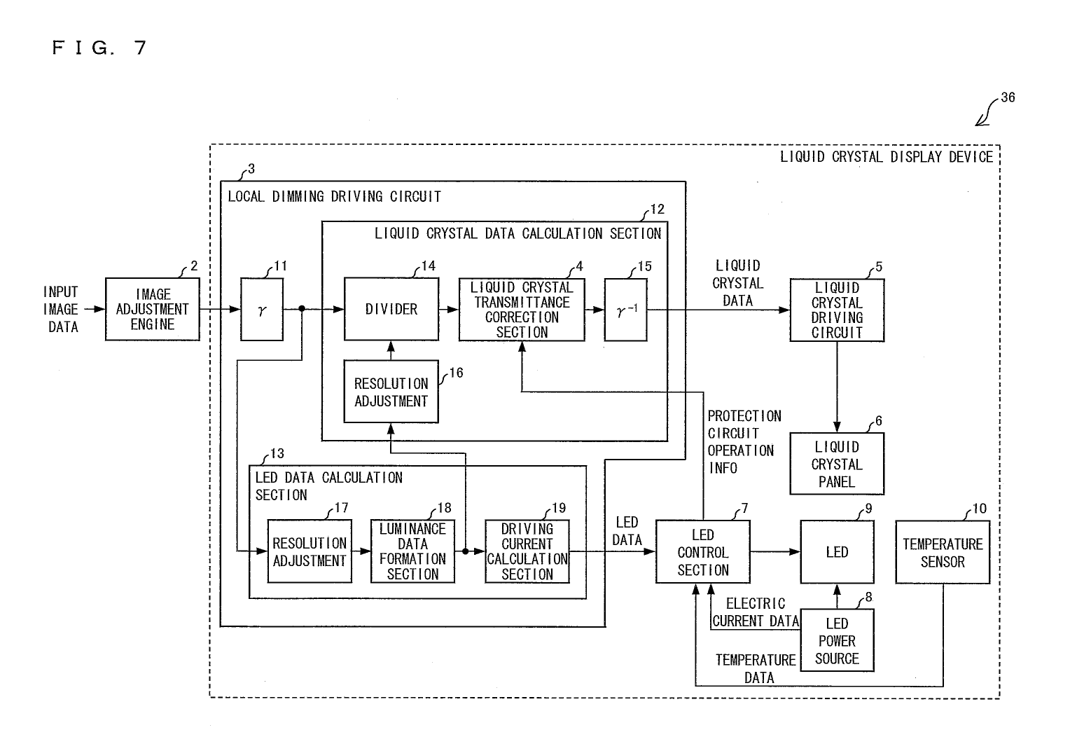

Another embodiment of the present invention will be described below with reference to FIG. 7. Note that an arrangement that is not described in Example 2 is the same as in Example 1. Further, for the sake of easy explanation, members and configurations having the like functions as the figures described in Example 1 are denoted by the like reference signs and the detailed description thereof is omitted.

FIG. 7 is a block diagram of a liquid crystal display device 36 according to Example 2. The liquid crystal display device 35 is different from the liquid crystal display device 1 of FIG. 1 in that the liquid crystal transmittance correction section 4 is provided in the local dimming driving circuit 3. The liquid crystal display device 36 includes the liquid crystal transmittance correction section 4 between the divider 14 and the γ inverse transform section 15.

The local dimming driving circuit 3 is generally formed as an LSI (large scale integrated circuit) because the local dimming driving circuit 3 is a large scale circuit. Unlike the local dimming driving circuit 3 of FIG. 1, the local dimming driving circuit 3 of FIG. 7 is arranged such that the liquid crystal transmittance correction section 4 is provided inside the LSI and buses of input and output signals of the liquid crystal transmittance correction section 4 are provided inside the LSI. This makes it possible to obtain wider bus widths of the input and output signals in comparison with a case where the liquid crystal transmittance correction section 4 is provided outside the local dimming driving circuit 3 as illustrated in FIG. 1. As a result, calculation accuracy is improved.

Further, the arrangement of FIG. 7 in which the liquid crystal transmittance correction section 4 is included in the local dimming driving circuit 3 is different from the arrangement of FIG. 1. Processing of the liquid crystal transmittance correction section 4 is undergone before processing of the γ inverse transform section 15. Unlike FIG. 4(c), when the liquid crystal correction section 4 of FIG. 7 corrects the transmittance, the liquid crystal correction section 4 does not need to compensate the luminance in consideration of the voltage-luminance characteristic of the liquid crystal panel 6 including the liquid crystal driving circuit 5. This feature is also different from the arrangement of FIG. 1.

### Example 3

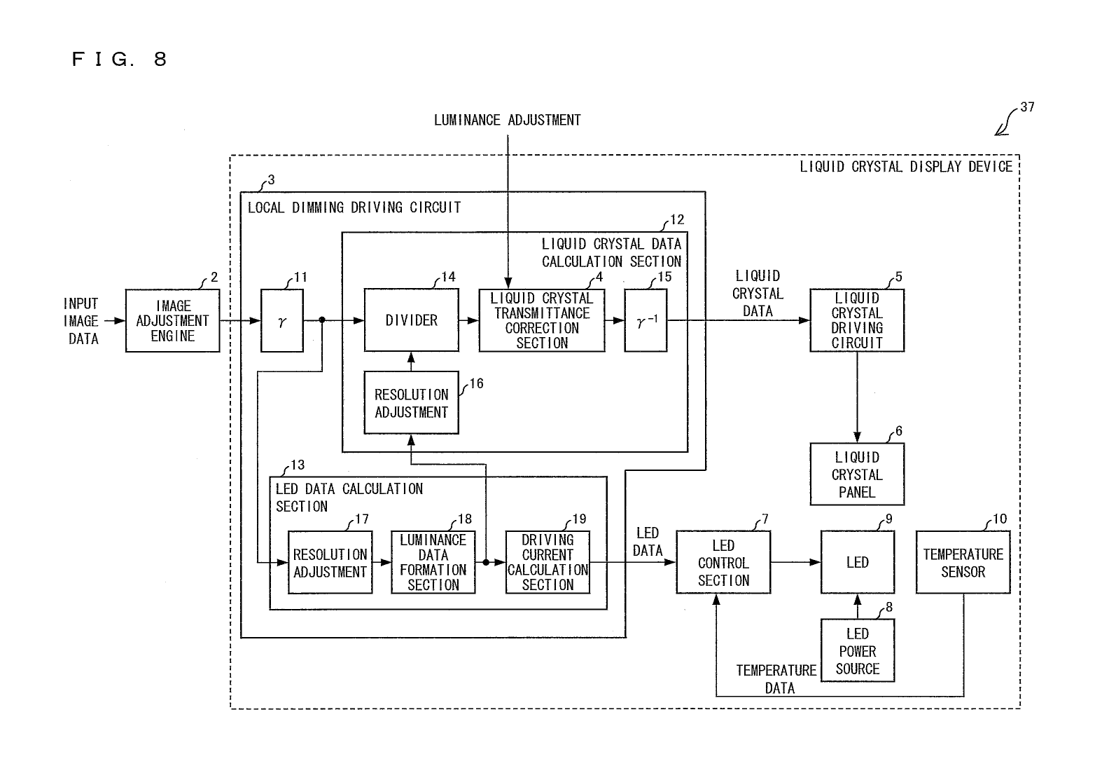

Still another embodiment of the present invention will be described below with reference to FIG. 8. Note that an arrangement that is not described in Example 3 is the same as in Examples 1 and 2. Further, for the sake of easy explanation, members and configurations having the like functions as the figures described in Examples 1 and 2 are denoted by the like reference signs and the detailed description thereof is omitted.

FIG. 8 is a block diagram of a liquid crystal display device 37 according to Example 3. In a case where an LED has a large enough capacity for an amount of an output current with sufficient allowance so that an LED protection circuit of an LED power source is necessary, the liquid crystal display device 37 according to Example 3 improves its display luminance, without causing an increase in amount of light emitted from the LED, i.e., an increase in consumption power, by supplying the luminance adjustment information to the liquid crystal transmittance correction section 4 from the outside the liquid crystal display device. Note that the liquid crystal display device 37 of FIG. 8 has an arrangement in which the liquid crystal transmittance correction section 4 is provided in the local dimming driving circuit 3, similarly to the liquid crystal display device 36 of Example 2. However, the liquid crystal display device 37 of FIG. 8 may be arranged such that the liquid crystal transmittance correction section 4 is provided by which the local dimming driving circuit 3 is followed, similarly to the liquid crystal display device 1 of Example 1.

If the image quality is adjusted by the image processing engine 2 as is conventionally performed, the local dimming driving circuit 3 controls to increase the amount of the light emitted from the LED, and therefore the consumption power is increased. However, the display luminance of the liquid crystal display device 37 according to Example 3 can be improved by transmittance correction of the liquid crystal transmittance correction section 4, irrespective of the amount of the light emitted from the LED. This does not cause increase in the consumption power.

### Summary of Embodiments

The liquid crystal display devices 1 and 36 each can be arranged such that the liquid crystal transmittance correction section 4 receives protection circuit operation information of the LED backlight 9 from the protection section and the liquid crystal data is corrected on the basis of the protection circuit operation information.

According to the aforementioned arrangement, the liquid crystal transmittance correction section 4 can correct the liquid crystal data by performing feedback control based on the protection circuit operation information of the protection section.

Further, each of the liquid crystal display devices 1 and 36 may include the luminance data formation section 18 in which an average picture level of the display image 25 is obtained on the basis of the input image data signal, and may arranged such that the protection section controls the amount of the driving current of the LED backlight 9 on the basis of the average picture level of the display image 25, which average picture level is calculated in the luminance data formation section 18, and the liquid crystal transmittance correction section 4 corrects the liquid crystal data on the basis of the average picture level of the display image 25, which average picture level is calculated in the luminance data formation section 18.

According to the aforementioned arrangement, the liquid crystal transmittance correction section 4 can correct the liquid crystal data by performing feedforward control based on the average picture level of the display image 25, which average picture level is calculated by the luminance data formation section 18.

Further, the liquid crystal display devices 1 and 36 may be arranged such that (i) the LED backlight 9 is an area-based control backlight capable of adjusting an amount of light for each of the plurality of divisional areas and, (ii) in each area of the LED backlight 9, the amount of the driving current is limited by the protection section and the liquid crystal data is corrected by the liquid crystal transmittance correction section 4.

According to the aforementioned arrangement, the LED backlight 9 is divided into the plurality of divisional areas, and therefore an optimal value of the backlight can be set for each divisional area, which in turn can reduce the consumption power of the whole backlight.

Further, the liquid crystal display device 37 may be arranged such that the LED backlight 9 is an area-based control backlight capable of adjusting an amount of light for each of the plurality of divisional areas. Each area of the LED backlight 9 has an arrangement in which the liquid crystal data is corrected by the liquid crystal transmittance correction section 4.

According to the aforementioned arrangement, the LED backlight 9 is divided into the plurality of divisional areas, and therefore an optimal value of the backlight can be set for each divisional area, which in turn can reduce the consumption power of the whole backlight.

Further, the liquid crystal display device 37 may arranged such that the liquid crystal transmittance correction section 4 is provided inside the display data formation section.

Further, a method for controlling display of each of the liquid crystal display devices 1 and 36 according to the examples, including, (i) a liquid crystal panel 6 in which a plurality of pixels are arranged, and (ii) an LED backlight 9 including an LED (light emitting diode) serving as a light source and being capable of adjusting an amount of light emitted from the LED backlight 9, the method includes: a liquid crystal data formation step (display data formation step) for forming, on the basis of an input image data signal, liquid crystal data to display an image on the liquid crystal panel 6; a backlight data formation step for forming, on the basis of the input image data signal, backlight data to adjust the amount of the light of the LED backlight 9; a protection step for limiting an amount of a driving current of the LED backlight 9 so that the amount of the driving current does not exceed a predetermined upper limit; and a liquid crystal data correction step (display data correction step) for correcting the liquid crystal data formed in the liquid crystal data formation step so as to compensate reduction in luminance of the backlight in a case where the amount of the driving current of the LED backlight 9 is reduced to the upper limit by the protection step.

Further, a method for controlling display of the liquid crystal display device 37 according to this example, including (i) a liquid crystal panel 6 in which a plurality of pixels are arranged, and (ii) an LED backlight 9 including an LED (light emitting diode) serving as a light source and being capable of adjusting an amount of light emitted from the LED backlight 9, the method includes: a liquid crystal data formation step (display data formation step) for forming, on the basis of an input image data signal, display data to display an image on the liquid crystal panel 6; a backlight data formation step for forming, on the basis of the input image data signal, backlight data to adjust an amount of emitted light of the LED backlight 9; and a liquid crystal data correction step (display data correction step) for increasing transmittance of a liquid crystal by (i) receiving luminance adjustment information from an outside of the liquid crystal display device 37 and (ii) correcting, on the basis of the luminance adjustment information, the liquid crystal data formed by the display data formation step.

Further, in the methods for controlling display of the liquid crystal display devices 1, 36, and 37, the LED backlight 9 is an area-based control backlight capable of adjusting an amount of light for each of the plurality of divisional areas. Each divisional area of the LED backlight 9 has an arrangement in which each step is controlled by the corresponding area of the LED backlight 9.

The present invention is not limited to the description of the embodiments above, and may be modified in numerous ways by a skilled person as long as such modification falls within the scope of the claims. An embodiment based on a proper combination of technical means disclosed in different embodiments is encompassed in the technical scope of the present invention.

### INDUSTRIAL APPLICABILITY

A display device and a method for controlling display according to the present invention each can prevent reduction in display luminance, without causing an increase in amount of light emitted from a light emitting element. Therefore, the display device and the method for controlling display are suitably applied to a liquid crystal display device including a backlight unit and a liquid crystal panel.

### REFERENCE SIGNS LIST

1 liquid crystal display device
2 image adjustment engine
3 local dimming driving circuit (backlight data formation section)
4 liquid crystal transmittance correction section (display data correction section)
5 liquid crystal driving circuit
6 liquid crystal panel (liquid crystal display panel)
7 LED control section
8 LED power source
9 LED backlight (area-based control backlight section, area-based control backlight)
10 temperature sensor section
11 γ transform section
12 liquid crystal data calculation section
13 LED data calculation section
14 divider
15 γ inverse transform section
16 resolution adjustment section
17 resolution adjustment section
18 luminance data formation section (APL calculation means)
19 driving current calculation section
20 input image
21 LED data
22 liquid crystal data
23 LED driving output data
24 corrected liquid crystal data
25 display image
26 input image
27 LED data
28 liquid crystal data
30 display image
31 center section
32 right end section
33 left end section
34 reference sign
35 clip
36 liquid crystal display device
37 liquid crystal display device
B correction amount
I electric current limited amount

1. A liquid crystal display device including (i) a liquid crystal display panel in which a plurality of pixels are arranged and (ii) an area-based control backlight section including a light emitting diode serving as a light source and being capable of adjusting an amount of light emitted from the area-based control backlight section, the liquid crystal display device comprising:
a display data formation section for forming, on the basis of an input image signal, display data to display an image on the liquid crystal display panel;
a backlight data formation section for forming, on the basis of the input image signal, backlight data to adjust the amount of the light of the area-based control backlight section;
a protection section for limiting an amount of a driving current of the area-based control backlight section so that the amount of the driving current does not exceed a predetermined upper limit; and
a display data correction section for correcting the display data formed in the display data formation section so as to compensate reduction in luminance of the backlight in a case where the amount of the driving current of the area-based control backlight section is reduced to the upper limit by the protection section.

2. The liquid crystal display device according to claim 1, wherein the display data correction section receives, from the protection section, driving current information of the area-based control backlight section, and corrects the display data on the basis of the driving current information.

3. The liquid crystal display device according to claim 1, further comprising:
APL calculation means for obtaining an average picture level of a display image on the basis of the input image signal, wherein:
the protection section controls the amount of the driving current of the area-based control backlight section on the basis of the average picture level of the display image, which average picture level is calculated by the APL calculation means; and
the display data correction section corrects the display data on the basis of the average picture level of the display data, which average picture level is calculated by the APL calculation means.

4. The liquid crystal display device according to claim 1, wherein:
the area-based control backlight section is an area-based control backlight which is divided into a plurality of divisional areas and is capable of adjusting an amount of light per each of the plurality of divisional areas; and
per each of the plurality of divisional areas, (i) the protection section limits the amount of the driving current and (ii) the display data correction section corrects the display data.

5. A liquid crystal display device including (i) a liquid crystal display panel in which a plurality of pixels are arranged and (ii) an area-based control backlight section including a light emitting diode serving as a light source and being capable of adjusting an amount of light emitted from the area-based control backlight section, the liquid crystal display device comprising:
a display data formation section for forming, on the basis of an input image signal, display data to display an image on the liquid crystal display panel;
a backlight data formation section for forming, on the basis of the input image signal, backlight data to adjust the amount of the light of the area-based control backlight section; and
a display data correction section for increasing transmittance of a liquid crystal by (i) receiving luminance adjustment information from an outside of the liquid crystal display device and (ii) correcting, on the basis of the luminance adjustment information, the display data formed by the display data formation section.

6. The liquid crystal display device according to claim 5, wherein:
the area-based control backlight section is an area-based control backlight which is divided into a plurality of divisional areas and is capable of adjusting the amount of the light per each of a plurality of divisional areas; and
the display data correction section corrects the display data per each divisional area of the area-based control backlight section.

7. The liquid crystal display device according to claim 1, wherein the display data correction section is provided inside the display data formation section.

8. A method for controlling display of a liquid crystal display device including (i) a liquid crystal display panel in which a plurality of pixels are arranged and (ii) an area-based control backlight section including a light emitting diode serving as a light source and being capable of adjusting an amount of light emitted from the area-based control backlight section, the liquid crystal display device, the method comprising:
a display data formation step for forming, on the basis of an input image signal, display data to display an image on the liquid crystal display panel;
a backlight data formation step for forming, on the basis of the input image signal, backlight data to adjust the amount of the light of the area-based control backlight section;
a protection step for limiting an amount of a driving current of the area-based control backlight section so that the amount of the driving current does not exceed a predetermined upper limit; and
a display data correction step for correcting the display data formed in the display data formation step so as to compensate reduction in luminance of the backlight in a case where the amount of the driving current of the area-based control backlight section is reduced to the upper limit by the protection step.

9. A method for controlling display of a liquid crystal display device including (i) a liquid crystal display panel in which a plurality of pixels are arranged and (ii) an area-based control backlight section including a light emitting diode serving as a light source and being capable of adjusting an amount of light emitted from the area-based control backlight section, the method comprising:
a display data formation step for forming, on the basis of an input image signal, display data to display an image on the liquid crystal display panel;
a backlight data formation step for forming, on the basis of the input image signal, backlight data to adjust the amount of the light of the area-based control backlight step; and
a display data correction step for increasing transmittance of a liquid crystal by (i) receiving luminance adjustment information from an outside of the liquid crystal display device and (ii) correcting, on the basis of the luminance adjustment information, the display data formed by the display data formation section.

10. The method for controlling display of a liquid crystal display device according to claim 8, wherein:
the area-based control backlight section is an area-based control backlight which is divided into a plurality of divisional areas and is capable of adjusting the amount of the light per each of a plurality of divisional areas; and
all the steps are carried out per each divisional area of the area-based control backlight section.
